(19) United States
(12) Patent Application Publication
(10) Pub. No.: US 2005/0140510 A1
(43) Pub. Date: Jun. 30, 2005

(54) Environmental monitoring module and method

(75) Inventors: Bryan Elwood, (US); Richard Bair, Weaverville, NC (US); Walter Tipton, Asheville, NC (US)

Correspondence Address: BAKER & HOSTETLER LLP;Suite 1100, Washington Square, 1050 Connecticut Avenue, N.W., Washington, DC, 20036, US

(73) Assignee: Kendro Laboratory Products, LP (DE Corp.)

(21) Appl. No.: 10/735,618

(22) Filed: Dec. 16, 2003

(51) Int. Cl. G06F 11/00

(52) U.S. Cl. 340/540

(57) ABSTRACT

To remotely diagnose and control equipment, a sensor attached the equipment is queried. This sensor generates a signal in response to an environmental condition of the equipment. In addition, the signal is received and a value is calculated based on the signal and a response curve of the sensor. Furthermore, the calculated value is compared to a range between a first value and a second value and a backup system attached to the equipment is modulated in response to the calculated value being outside the first value and the second value.

### CROSS REFERENCE TO RELATED APPLICATIONS

This application claims priority to U.S. patent application Ser. No. 10/022,194, filed Dec. 20, 2001, titled Equipment Monitoring System and Method, the disclosure of which is incorporated herein by reference in its entirety.

### FIELD OF THE INVENTION

The present invention relates generally to monitoring of equipment. More particularly, the present invention relates to remote site monitoring through the use of embedded devices in the equipment.

### BACKGROUND OF THE INVENTION

A large number of companies, universities and even individuals purchase commercial equipment such as refrigerators or coolers for storing environmentally sensitive products for a variety of reasons such as experiments, research or storage. A great deal of time is spent monitoring this equipment to ensure it is functioning properly. Failure to do so could have dire consequences. The contents contained in the equipment could be destroyed if the device fails and the temperature inside becomes a hazard to the contents. Such a predicament can have significant financial burden on the owner of the equipment as well as those who have contents therein.

To help alleviate this potential threat, companies monitor the devices with a variety of devices. Some solutions have been a built-in temperature gauge. The readout from the gauge can be placed on the outside or inside of the equipment. An individual, whose responsibility it is to monitor the equipment, must check the gauges to ensure operability.

However, this system or method is prone to error. For instance, if the gauge breaks and is pegged on the last known temperature, a simple reading of the gauge is not sufficient.

Furthermore, the gauge measures the overall temperature in the equipment. Some areas of the refrigerator might run colder or even warmer than what the temperature gauge is actually reporting. This could have a tremendous impact on specimens in these areas of the equipment.

Another error is that the individual monitoring the equipment cannot be on-site twenty-four hours a day and seven days a week. Systems break down at all times during the day. Extended periods without monitoring can be costly and damaging. To employ a system that uses a constantly staffed monitoring system would be time consuming and costly.

Finally, the products on the market today cannot predict upcoming service problems. Accordingly, it is desirable to provide a system that is capable of monitoring equipment on a continuous basis as well as predict possible failure, which is resolved in an efficient manner.

Accordingly, it is desirable to provide a method and apparatus capable of overcoming the disadvantages described herein at least to some extent.

### SUMMARY OF THE INVENTION

The foregoing needs are met, to a great extent, by the present invention, wherein in one respect an apparatus and method is provided that in some embodiments remotely monitors equipment.

An embodiment of the present invention pertains to an apparatus for monitoring equipment. The apparatus includes a sensor and a node. The sensor is attached to the equipment and senses an environmental condition of the equipment. The node receives signals from the sensor. In response to the environmental condition being outside a range between a first value and a second value, the node controls a backup system to substantially return the environmental condition to between the first value and the second value.

Another embodiment of the present invention relates to an apparatus to remotely monitor equipment. The apparatus includes a means for querying a sensor attached the equipment. This sensor generates a signal in response to an environmental condition of the equipment. In addition, the apparatus includes a means for receiving the signal and a means for calculating a value based on the signal and a response curve of the sensor. Furthermore, the apparatus includes a means for comparing the calculated value to a range between a first value and a second value and a means for modulating a backup system attached to the equipment in response to the calculated value being outside the first value and the second value.

Yet another embodiment of the present invention pertains to a method that provides remote diagnostic and control capability for equipment. In this method, a sensor attached the equipment is queried. This sensor generates a signal in response to an environmental condition of the equipment. In addition, the signal is received and a value is calculated based on the signal and a response curve of the sensor. Furthermore, the calculated value is compared to a range between a first value and a second value and a backup system attached to the equipment is modulated in response to the calculated value being outside the first value and the second value.

Yet another embodiment of the present invention relates to a computer readable storage medium on which is embedded one or more computer programs implementing a method that provides remote diagnostic and control capability for equipment. The one or more computer programs include a set of instructions for querying a sensor attached the equipment. This sensor generates a signal in response to an environmental condition of the equipment. In addition, the one or more computer programs include a set of instructions for receiving the signal and calculating a value based on the signal and a response curve of the sensor. Furthermore, the one or more computer programs include a set of instructions for comparing the calculated value to a range between a first value and a second value and modulating a backup system attached to the equipment in response to the calculated value being outside the first value and the second value.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a block diagram of a system architecture for an equipment environment monitoring system according to an embodiment of the invention.

FIG. 2 is a block diagram of a system architecture for a controller according to an embodiment of the invention.

FIG. 3 is a block diagram of a system architecture for a node according to an embodiment of the invention.

FIG. 4 is a flow diagram of a method illustrating the steps that may be followed in accordance with an embodiment of the invention.

### DETAILED DESCRIPTION OF THE PREFERRED EMBODIMENT

A preferred embodiment of the present invention provides an apparatus that monitors and controls the operation of equipment such as high-grade appliances (e.g. industrial grade refrigerators or coolers that house environmentally sensitive products). The invention accomplishes this by the use of a controller that is attached to the equipment and able to communicate with the apparatus through a communication medium such as a direct connection, and/or a network. The communication medium may further include wired, wireless, fibre, and/or the like. The apparatus queries the equipment through the controller on a continuous basis to obtain status and operability of the equipment.

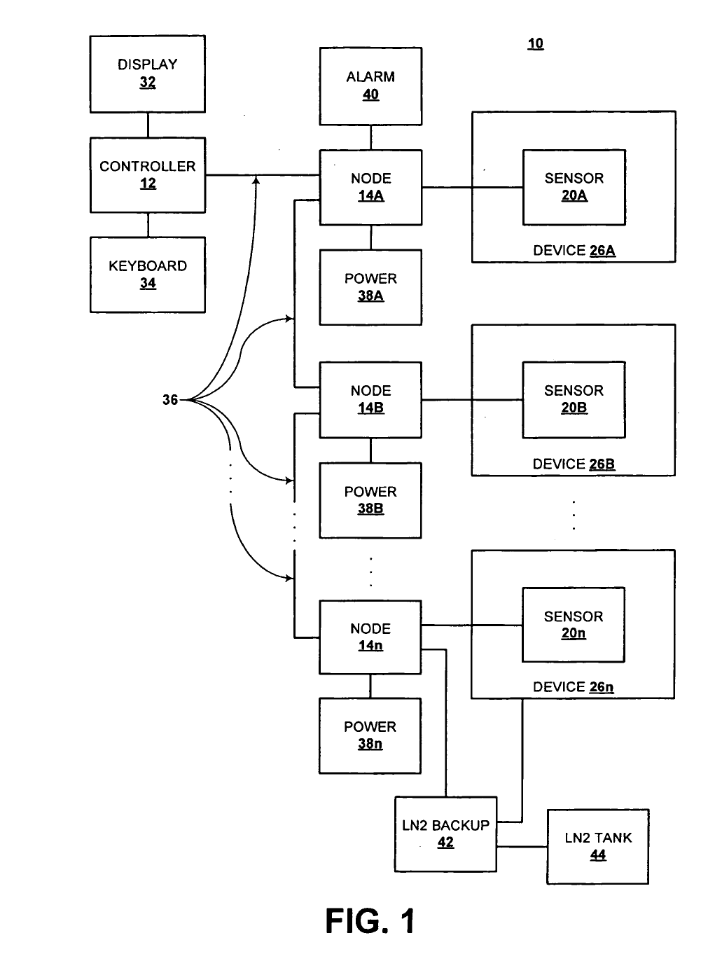

The invention will now be described with reference to the drawing figures, in which like reference numerals refer to like parts throughout. As shown in FIG. 1, an equipment environment monitoring system (“EEMS”) 10 is configured to monitor environmental conditions in at least one piece of equipment. The EEMS 10 includes a controller 12 configured to communicate with a plurality of nodes 14A-n. These nodes 14A-n are configured to receive signals from a plurality of respective sensors 20A-n. Also shown in FIG. 1 is a plurality of equipment 26A-n being monitored by the EEMS 10. While three pieces of equipment 26A-n are shown in FIG. 1, as illustrated by the ellipses, the EEMS 10 of various embodiments of the invention are not limited to monitoring the three pieces of equipment shown, but rather, any reasonable number of pieces of equipment such as 1 to 1,000 or more pieces of equipment may be monitored by the EEMS 10. The type of equipment being monitored may include any suitable device. Specific examples of suitable types of equipment include incubators, refrigerators, freezers, storage cabinets, and the like. Additionally, suitable types of devices include devices in which it may be advantageous to monitor and/or control environmental conditions.

The controller 12 is preferably a computing device such as a personal computer (PC), laptop, handheld, host computer, server, or the like. As such, the controller 12 is operable to execute computer readable code, display information to a user and receive input from the user. In this regard, the controller 12 includes a display 32 to display information to the user and a keyboard 34 operable to receive input from the user. In addition, the controller 12 may include any suitable pointing device such as a mouse or touch pad as well as any other suitable computer peripheral device. The controller 12 is further configured to communicate with any suitably attached device. This attachment may be in the form of wired and/or wireless communication. To communicate with the nodes 14A-n, the controller 12 is preferably connected to the nodes 14A-n via a network 36. In a preferred form, the network 36 utilizes a standardized communication protocol such as Recommended Standard 485 (RS-485) developed by the Telecommunications Industry Association (TIA) in association with the Electronic Industries Alliance (EIA).

The nodes 14A-n receive signals from the sensors 20A-n and relay these signals or environmental data associated with the signals to the controller 12. For example, the sensor 20A may include a thermocouple operable to vary voltage passing therethrough as a function of temperature. Depending upon the workings of the particular sensor utilized, the nodes 14A-n are operable to send a query signal to the sensor in order to receive a response signal from the sensor. For example, the node 14A may apply a predetermined voltage across the sensor 20A and thereby receive a voltage in response to the conditions in which the sensor 20 is subjected. In an embodiment of the invention, the node 14A includes a microprocessor, RS-485 transceiver, and at least one analog to digital (A/D) converter. The node 14A receives these voltage signals from the sensor 20A and converts these analog signals into digital format. The digital signals are processed by the microprocessor and transmitted via the RS-485 transceiver to the controller 12. In various embodiments of the invention, the processing performed by the node 14A includes converting the signals from the sensor 20A into temperature values or other such environmental values, encoding the digital signal into a format compatible with the network 36, and/or the like.

The nodes 14A-n additionally communicate with the controller 12 and respond to commands from the controller 12. In a particular example, the node 14A may query the sensor 20A and reply with a temperature reading for the piece of equipment 26A in response to a query from the controller 12. In another example, the node 14n may modulate the LN2 backup 42 in response to commands from the controller 12.

The nodes 14A-n further include power supplies 38A-n. These power supplies 38A-n include power supplied via a power line and/or via battery backup. In addition, the nodes 14A-n are configured to interface with a variety of other components such as an alarm 40, a liquid nitrogen (LN2) backup 42, and the like. The alarm 40 emits a visual and/or auditory signal in response to a signal from at least one of the nodes 14A-n and the controller 12. The LN2 backup 42 includes an LN2 supply 44. The LN2 backup 42 is configured to regulate the flow of LN2 from the LN2 supply 44 to an attached device. As shown in FIG. 1, the LN2 backup 42 is attached to the piece of equipment 26n, however, in other embodiments of the invention, the LN2 backup 42 may be attached to any or all of the pieces of equipment 26A-n. In response to environmental conditions within the piece of equipment 26n being outside predetermined parameters, the LN2 backup 42 is configured to modulate the flow of LN2 to the piece of equipment 26n. These predetermined parameters are based on a variety of factors such as: user specified temperature range and/or other ranges of environmental conditions; equipment manufacturer's specifications; and the like.

The nodes 14A-n optionally include a display, radio frequency (RF) transceiver, infrared (Ir) transceiver, and the like. The optional display is operable to display information to the user. In particular, the optional display may be configured to display environmental conditions pertaining to a specific piece of equipment. The various optional transceivers provide the capability to communicate via a variety of methods. In this manner, the nodes 14A-n may be installed according to the requirements of the particular application.

The sensors 20A-n include any suitable environmental sensors. Examples of suitable environmental sensors include devices configured to sense temperature, CO₂, O₂, N₂, humidity, pH, barometric pressure, and the like. The sensors 20A-n are disposed in such a manner so as to sense the environmental conditions in or around the pieces of equipment 26A-n. The sensors 20A-n are configured to relay signals associated with the sensed environmental conditions to the respective node 14A-n. Although each of the sensors 20A-n is shown attached to a respective piece of equipment 26A-n in FIG. 1, in various other embodiments of the invention, each piece of equipment 26A-n may include one or more sensors.

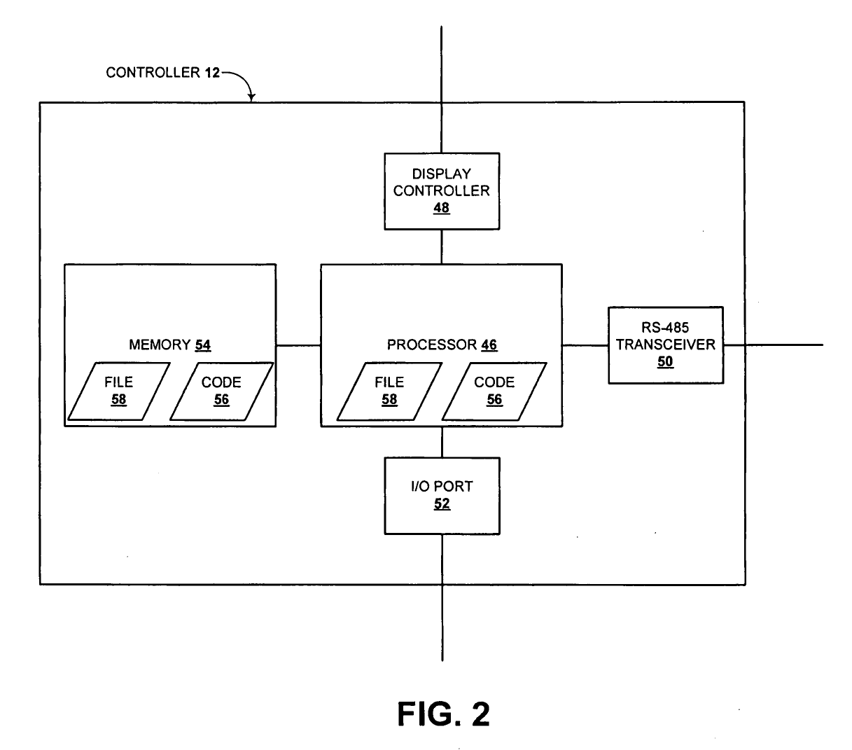

FIG. 2 is a block diagram of a system architecture for the controller 12 according to an embodiment of the invention. As shown in FIG. 2, the controller 12 includes a processor 46 configured to intercommunicate with a display controller 48, RS-485 transceiver 50, I/O port 52, and memory 54.

The processor 46 is configured to execute a computer readable code 56. In response to this code 56, the processor 46 is configured to query the nodes 14A-n, receive sensed environmental conditions of the equipment 26A-n, and store these environmental conditions to a data file 58. This file 58 may be in the form of a table configured to store a plurality of entries associated with the equipment 26A-n. Information stored to these entries include one or of an essentially unique identifier, environmental conditions, acceptable environmental condition ranges as specified by the equipment manufacturer and/or the user, alarm states, power out, and the like.

The display controller 48 is configured to receive commands from the processor 46 and generate signals to modulate the display 22. The RS-485 transceiver 50 generates signals in response to commands from the processor 46 and transmits these signals across the network 36. The RS-485 transceiver 50 further receives signals transmitted across the network 36, generates data based on these signals and forwards this data to the processor 46. The I/O port 52 receives signals from an input device such as the keyboard 34, generates data based on these signals and forwards this data to the processor 46. The memory 54 stores information received from the processor 46 such as the code 56 and the file 58. The memory 54 further provides this information to the processor 46. The memory 54 may exist in a variety of forms such as, for example, random access memory (RAM), disk storage, electronic erasable programmable read only memory (EEPROM), and/or the like.

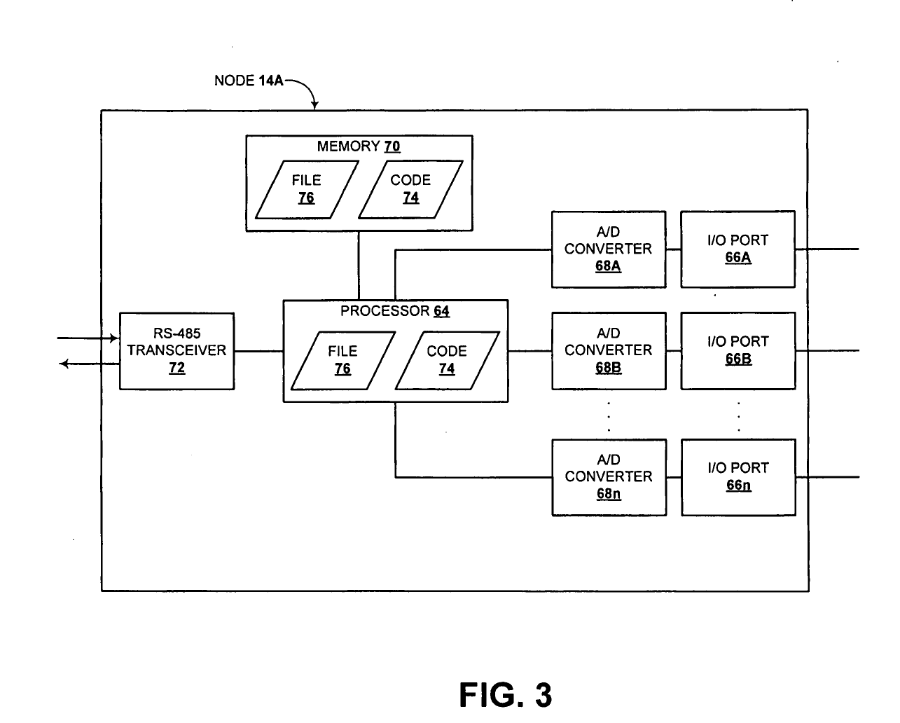

FIG. 3 is a block diagram of a system architecture for the node 14A according to an embodiment of the invention. The nodes 14B-n are similar to the node 14A and thus, for the sake of brevity, the description of the node 14A also pertains to the description of the nodes 14B-n. As shown in FIG. 3, the node 14A includes a processor 64 configured to intercommunicate with a plurality of I/O ports 66A-66n. Depending upon the output of the sensors 20A-n, the node 14A may utilize one or more A/D converters 68A-n to convert analog signals to digital signals and vise versa. That is, if the output of a sensor attached to I/O port 66A is in digital format, the A/D converter 68A may not be present or, if present, may pass the digital signal from the I/O port 68A to the processor 64 without substantially altering the digital signal.

The processor 64 is configured to execute a computer readable code 74. In response to this code 74, the processor 64 is configured to query any attached sensor 20A-n, receive sensed environmental conditions from these one or more sensors 20A-n, and store these environmental conditions to a data file 76. This file 76 may be in the form of a list or table configured to store a plurality of entries associated with each of the one or more sensors 20A-n. Information stored to these entries include one or more of environmental conditions, acceptable environmental condition ranges as specified by the manufacturer and/or the user, alarm states, power out, and the like. Additionally, the processor 64 is configured to receive commands from the controller 12 via the RS-485 transceiver 72. In response to these commands, the processor 64 is configured to generate the essentially unique identifier and forward this unique identifier along with information from the file 76 to the RS485 transceiver 72.

The unique identifier or identification number (ID) is a key component of the system, especially in the situation where the EEMS 10 is monitoring multiple pieces of equipment 26A-n not necessary identical in nature. In the preferred embodiment, the ID is assembled using an array of data that is unique to each piece of the equipment 26A-n. Table 1 below illustrates one such method for assembling the ID.

TABLE 1

| ID Format | |
|---|---|
| Field Name | Example |
| First Character Manufactured Month/Year | S |
| Two Digit Numeric Shipped Day | 25 |
| Second Character Manufactured Month/Year | H |
| Six Numeric Unique ID | 383645 |
| Two Character Shipped Month/Year | TH |
| Device Brand | R |
| Device Feature Set | A |
| Device Type | 4 |

In this example, the ID is compiled using a number of pieces of data that helps the EEMS 10 decode certain aspects of the equipment 26A-n. This is not the only way to construct an ID but it does aid in evaluating each piece of equipment 26A-n as well as during initial setup of the EEMS 10 in general and, more particularly, each new or replacement piece of equipment 26A-n. The software code 56 and 74 is able to deal with certain pieces of equipment 26A-n by merely evaluating the last three bits of data on the ID and comparing it to the acceptable limits of operation for that particular piece of equipment 26A-n.

The ID constructed, as detailed in Table 1, is helpful in situations where a third-party is monitoring the equipment 26A-n. This third-party, in this instance, is usually referred to as a monitoring service. Therefore, when a problem does occur, the information contained in the ID is critical to diagnosing and properly servicing the equipment 26A-n.

The processor 64 is further configured to modify the code 74 according to commands from the controller 12. For example, in response to a new or different sensor 20A-n being attached to the node 14A, the controller 12 may forward computer drivers associated with the sensor 20A-n. In another example, computer drivers associated with new or different equipment 26A-n may be received by the processor 64 and utilized to modify the code 74. In this manner, the code 74 may be update.

The memory 70 stores information received from the processor 64 such as the code 74 and the file 76. The memory 70 further provides this information to the processor 64. The memory 70 may exist in a variety of forms such as, for example, RAM, disk storage, EEPROM, and/or the like.

The query process involves the controller 12 communicating with the equipment 26A-n through the node 14A-n. The messages are sent space parity and are intended for only one node 14A-n. Just prior to these messages, the network address is broadcast at mark parity so that when the embedded device receives the mark address, twice consecutively, the node 14A-n begins to turn its attention to the message received. In other words, it is placed into reading mode. This enables the node 14A-n to listen for the specific types of messages.

For every outbound message, a known response is expected from a node 14A-n. Characteristics of the expected response, such as the number of bytes in the message and field parameters, are defined. In addition, the embedded controller can issue a longitudinal redundancy check failure error message. At any rate, the controller 12 can determine if a message has been received properly, in error, or not at all when one was expected. If a failure does occur, the specific query message is resent up to three times by the controller 12. On the third fail, the controller 12 removes the equipment 26A-n from the network and no features will be performed on this equipment 26A-n and an icon of the equipment 26A-n is updated indicating the communication fault mode. The communication fault mode is logged to the file 58.

At this point, the node 14A-n enters a communication recovery mode. At a defined time interval, the command query requesting the serial number for the node 14A-n is issued by the controller 12. If the correct response is received, the controller 12 will restore the equipment 26A-n on the network 36 and update the icon appropriately. The restoration process is also logged to the file 58. The user has the capability to view and generate reports from this file 58. In addition, the user can purge the file 58 at anytime. The file 58 also contains an integer error code, which provides useful diagnostic insight as to what the communications fault entails.

Below is a non-exhaustive list of queries and responses employed with the present invention for communication between the controller 12 and the nodes 14A-n. These commands are designed to be transcribed by an 80C32 microcontroller. The message structure employed by the invention is a quasi-ASCII ModBUS message architecture. The error checking is commonly referred to as a longitudinal-redundancy-check.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

Response: Retrieve Historic Log Database

The software code, in the preferred embodiment, has a number of features for collecting and observing the data. The preferred embodiment provides four basic views for examining the data. They are (a) set-point; (b) data; (c) ten minute, real time graph; and (d) historic graph. These views provide the user with different insights to the currently selected device.

The set-point view allows the user to remotely select control parameters for a particular piece of equipment 26A-n. It distinguishes between storage, incubation and refrigeration devices such as a minus thirty, minus 20 and plus 4 and ultra low temperature freezers as well as feature set (e.g. A, B, C which correspond to house, private label with alarm and private label) in order to provide the correct adjustable parameters. The differentiation of the device types and features sets is determined by decoding the ID of the equipment 26A-n.

The set-point view requires the user to enter a password that has been previously been set in order for a change in settings to be accepted and written out to the embedded controller. If no activity occurs on the set-point view for thirty seconds, then the view times out.

The data view features the ability for the user to view the entire historic logging history database table for the selected equipment 26A-n. The user selects the current data or the archived data table. This view also permits some basic statistical analysis. The user selects a range of records and have the average, minimum and maximum of the selected range reported in a message box. A report of the file 58 can also be generated and printed.

The real-time graph or ten-minute history view collects current temperature data in a graphical format every fifteen seconds. Once ten minutes worth of data has been collected, approximately forty points, the most current data is displayed. If the selected equipment 26A-n changes, then the ten-minute data buffer is cleared and commences to re-build ten minutes worth of data.

The historic logging view enables the user to select a data range and to look at the historic logging parameters for up to seven series on one graph. The user can select which logged variable to view on the graph. The user can also zoom and drag the graph to customize the graph. A hard copy of the graph is also obtainable.

Feature Set

The following are a few feature sets included in the software in the preferred embodiment.

A. Current Temperature Scan

This feature updates the current temperature in numeric format for the selected equipment 26A-n. If the selected equipment 26A-n changes, then numerical data is cleared at the next sixty-second rollover. The newly selected device will be queried and reported. This feature is independent of the current data view that the user has selected.

B. Alarm Scan

This feature scans all the equipment 26A-n that are on the users network 36 every five minutes for active and past alarms for power failure, warm temperature and cold temperature alarm. If the equipment 26A-n has any alarms, the icon in the equipment 26A-n window is changed to an alarm icon visually indicating the alarm status temperature. This feature also looks for active warm alarm and cold alarms. If either alarm has been active for at least one hour for any equipment 26A-n on the user's network 36, then a call is placed via a user-installed modem to a user entered telephone number. The call repeats a default message recorded as a WAV file.

C. Historic Logging

This feature scans all the equipment 26A-n with historic logging enabled at a user selectable interval. Current temperature, offset, set-point, warm alarm set-point, cold alarm set-point, and all the variables are recorded and time stamped to a database table for each equipment 26A-n in the network 36.

D. Supervisory Utilities

This option allows programming of an original ID or to overwrite an ID on a point-to-point network. In addition, the user can read the voltage on any of the eight available ADC channels and have the voltage output to a window message box. The user can enter in any external RAM address and receive the data at that address and the one above it in the memory 54.

E. Cumulative On-Time

This feature enables the user to determine the total cumulative on time performance for the selected equipment 26A-n. It reports the seconds, minutes, hours, days, months and years that a equipment 26A-n has been on.

F. Excursions

This feature allows users to remotely examine the excursions of the currently selected equipment 26A-n.

G. Manufactured Date

This feature allows the user to know the manufactured data of the selected equipment 26A-n in month, day and year format.

H. Shipped Date

The feature allows a user to determine the date in month format for when the selected equipment 26A-n was shipped.

I. Force Delog

This feature allows a user too remotely force a delog cycle for the selected equipment 26A-n.

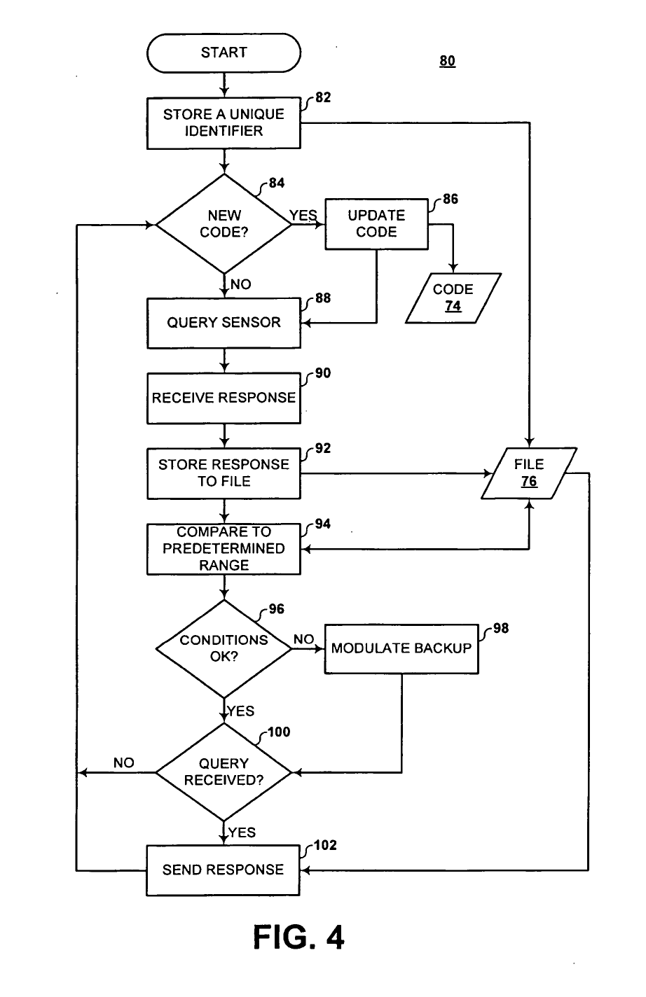

FIG. 4 is a flow diagram of a method 80 illustrating the steps that may be followed in accordance with an embodiment of the invention. In the following description of the method 80, the node 14A is referenced throughout. However, according to various embodiments of the invention, the method 80 may refer to some or all of the nodes 14A-n. Prior to the method 80, the various components of the EEMS 10 may be installed and power may be supplied. Additionally, as part of the installation, the code 74 is installed and the file 76 is generated. As shown in FIG. 4, the method 80 is initiated at step 82 by storing a substantially unique identifier associated with a piece of equipment 26A. This unique identifier is stored to the file 76 for example. In various embodiments of the invention, substantially unique identifier may be similar to the ID illustrated in Table 1.

At step 84, it is determined whether new code has been received. For example if the RS-485 transceiver 72 receives a code update message via the network 36 that is intended for the node 14A, it may be determined that new code has been received. This message may be forwarded to the processor 64 and, at step 86, utilized to update the code 74. If it is determined essentially no new code update messages have been received, the sensor 20A may be queried at step 88.

At step 86 the processor 64 updates the code 74 according to the code update message. Examples of code updates include traditionally firmware and software associated modifications. That is, firmware generally pertains to such operations as communication between the processor 64 and the sensor 20 and various “lower level” functioning. Whereas software is generally associated with such applications as database construction and administration, as well as, other “higher level” applications. In a particular example of a firmware update, drivers and/or a response curve associated with a newly installed sensor may be written to the code 74. In this manner, essentially any electronic sensor may be utilized by the node 14A and the EEMS 10. In a particular example of a software update, in response to the addition of a backup sensor, the code 74 may be modified so that sensor reading from the backup sensor are collected and stored to the file 76. However, the functions performed by software and firmware may overlap and need not be distinct. Following step 86, the sensor 20A may be queried at step 88.

At step 88 the sensor 20A is queried. For example, a particular voltage may be applied to the sensor 20A. In other embodiments of the invention, a plurality of sensors may be queried. Following the step 88, a response to the query is received at step 90.

At step 90 the response from the sensor 20A is received. For example, voltage across the sensor 20A may be measured and compared to the response curve of the sensor 20A to calculate a value for the sensed environmental condition. Following the step 90, the value calculated is stored at step 92.

At step 92 the value calculated is stored to the file 76. For example in a table including one or more of a date stamp field, a time stamp field, and a sensor reading field, the calculated value is stored to the sensor reading field. In addition, a date and/or time associated with the sensed environmental condition may be stored to the respective date stamp and/or time stamp fields. Following the step 92, the calculated value is compared to a predetermined range of values at step 94.

At step 94 the file 76 is accessed by the processor 64 and the calculated value is compared to the predetermined range of values. This predetermined range of values may be based upon one or more of: specifications of the equipment 26A, user defined parameters, and the like. More particularly, this range of values includes a first value and a second value. Each of these values representing one extreme such as a low or high temperature. As the EEMS 10 is operable to monitor essentially any piece of equipment, this predetermined range is dependent upon the particular situation and equipment utilized. Following step 94, it is determined if the calculated value is within the predetermined range of values at step 96.

At step 96 it is determined whether the calculated value is within the predetermined range of values. If it is determined that the calculated value is outside the predetermined range of values, a backup system may be modulated at step 98. If, at step 96, it is determined that the calculated value is within the predetermined value then, at step 100, it is determined whether a query has been received.

At step 98 the backup system is modulated in response to the calculated value being outside the predetermined range of values. For example, if the calculated temperature exceeds the predetermined range of temperatures, an LN2 system such as the LN2 backup 42 may be modulated to increase the flow of LN2 into the equipment 26A. In addition, an alarm such as the alarm 40 may be activated to alert the user. Furthermore, an error log may be generated and/or an error entry may be stored to the file 76. Following the step 98, it is determined whether a query has been received at step 100.

At step 100 it is determined if a query has been received via the network 36. For example, if the RS485 transceiver 72 receives a query message intended for the node 14A, it is determined that a query has been received. In response to the query, a response is forwarded to the controller 12 at step 102. If it is determined that a query has not been received at step 100 then, at step 84, it is determined if new code has been received.

At step 102 the file 76 is accessed by the processor 64 and information requested in the query is encoded in RS-485 format. This encoded information is forwarded across the network 36 by the RS-485 transceiver 72. Following the step 102, it is determined if new code has been received at step 84.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An apparatus for monitoring equipment comprising:
a first sensor attached to the equipment for sensing an environmental condition of the equipment; and
a node configured to receive signals from the first sensor, wherein in response to the environmental condition falling outside a range between a first value and a second value, the node is further configured to control a backup system to substantially return the environmental condition to between the first value the second value, wherein the node is detachably coupled in the immediate proximity of the equipment.

2. The apparatus according to claim 1, further comprising:
a file stored to the node, wherein the node stores the environmental conditions of the equipment to the file.

3. The apparatus according to claim 1, further comprising:
an alarm to emit at least one of a visual and auditory signal, the alarm being activated by the node in response to the environmental condition being outside the range between the first value and the second value.

4. The apparatus according to claim 1, further comprising:
a network; and
a controller to communicate with the node across the network.

5. The apparatus according to claim 4, wherein the controller queries the node for the environmental conditions.

6. The apparatus according to claim 5, further comprising:
a display device attached to the controller to display the environmental conditions.

7. The apparatus according to claim 6, further comprising:
an input device attached to the controller to provide a user with the capability to program the controller.

8. The apparatus according to claim 4, further comprising:
a computer code to control the actions of the node, wherein the controller updates the computer code across the network.

9. An apparatus to remotely monitor equipment, the apparatus comprising:
means for sensing an environmental condition of the equipment, wherein the means for sensing is attached to the equipment; and
node means that is attached to the equipment, the node means comprises:
means for receiving the signal;
means for calculating a value based on the signal and a response curve of the sensor;
means for comparing the calculated value to a range between a first value and a second value; and
means for modulating a backup system attached to the equipment in response to the calculated value being outside the first value and the second value.

10. The method according to claim 9, further comprising:
means for generating a file in the node means.

11. The method according to claim 10, further comprising:
means for storing a unique identifier associated with the equipment to the file.

12. The method according to claim 9, further comprising:
means for monitoring the node means across a network.

13. The method according to claim 12, further comprising:
means for updating a computer code in response to receiving code across the network.

14. The method according to claim 12, further comprising:
means for querying the node across the network for the environmental conditions; and
means for receiving the environmental conditions in response to the query.

15. A method that provides remote diagnostic and control capability for equipment, the method comprising:
detachably attaching a node to the equipment;
querying a sensor attached the equipment from the node, the sensor generating a signal in response to an environmental condition of the equipment;
receiving the signal at the node;
calculating a value based on the signal and a response curve of the sensor at the node;
comparing the calculated value to a range between a first value and a second value at the node; and
modulating a backup system attached to the equipment in response to the calculated value being outside the first value and the second value at the node.

16. The method according to claim 15, further comprising:
generating a file on the node.

17. The method according to claim 16, further comprising:
storing a unique identifier associated with the equipment to the file.

18. The method according to claim 15, further comprising:
monitoring the node across a network.

19. The method according to claim 18, further comprising:
updating a computer code in response to receiving code across the network.

20. The method according to claim 18, further comprising:
querying the node across the network for the environmental conditions; and
receiving the environmental conditions in response to the query.

21. (canceled)

22. (canceled)

23. (canceled)

24. (canceled)

25. (canceled)

26. (canceled)

27. The apparatus as in claim 1, wherein the node is further comprises a power supply, a central processing unit, a transceiver and plurality of sensor inputs.

28. The apparatus as in claim 27, wherein the node is configured to communicate with a computer network.

29. The apparatus as in claim 28, wherein the node is configured to communicate with another node.

30. The apparatus as in claim 28, wherein the node communicates with the computer network through RS-485 communications protocol.

31. The apparatus as in claim 30, wherein a controller is attached to the computer network.

32. The apparatus as in claim 31, wherein the controller is capable of configuring the node and the sensor.

33. The apparatus as in claim 31, further comprising a second senor attached to the equipment.
